(19) United States
(12) Patent Application Publication
(10) Pub. No.: US 2016/0091657 A1
(43) Pub. Date: Mar. 31, 2016

(54) BACKLIGHT MODULE

(71) Applicant: SHENZHEN TCL NEW TECHNOLOGY CO., LTD., Guangdong, (CN)

(72) Inventors: MINNA YANG, GUANGDONG (CN); SHENGSHENG WU, GUANGDONG (CN); JIANLIN LI, GUANGDONG (CN)

(21) Appl. No.: 14/785,683

(22) PCT Filed: Jan. 17, 2014
(86) PCT No.: PCT/CN2014/070831

§ 371 Date: Oct. 20, 2015

(30) Foreign Application Priority Data
Sep. 9, 2013 (CN) 201320560218.3

(51) Int. Cl. F21V 8/00

(52) U.S. Cl. CPC G02B 6/0088; G02B 6/0028; G02B 6/0023; G02B 6/0091; G02B 6/0073

(57) ABSTRACT

A backlight module comprising a lamp strip (10), a light guide plate (20), a quantum dot glass tube (30) and a fixing part (40). The fixing part (40) is a hollow structure. The quantum dot glass tube (30) being provided in the cavity of the fixing part (40) which is positioned between the lame strip (10) and the light guide plate (20). One side wall of the fixing part (40) is abutting on the frame of the lamp strip (10), and the other side wall of the fixing part (40) is engaging with the light guide plate (20). The fixing part (40) is utilized to place the quantum dot glass tube (30), so as to maintain proper distance among the lamp strip (10), the light guide plate (20) and the quantum dot glass tube (30), and fix the lamp strip (10) and the light guide plate (20).

### TECHNICAL FIELD

The present disclosure relates to liquid crystal display (LCD), and particularly to a backlight module.

### DESCRIPTION OF RELATED ART

In a conventional liquid crystal display, white LED is usually used as a backlight source, and a desired LCD backlight can be achieved through a reasonable arrangement of light guide plate and optical film. With increasing demand for high color gamut, high color saturation and energy-saving lamps, current solutions of white light source, high gamut and high color saturation in backlight are achieved by: ultraviolet LED with RGB phosphors; blue LED with RG (red and green) phosphors; blue LED with green LED plus red LED; and the like. Such methods can improve the color gamut, but they are difficult to be implemented and costly. Thus, quantum dot (QD) material is applied to the backlight module, through which, the traditional white LED light source is replaced by high-frequency spectrum light source (such as blue LED). Under irradiation of high-frequency light source, the QD material can be excited to produce different wavelength spectrums. By adjusting the size of the QD material, the color of the synthesized light can be adjusted, thus achieving requirement of backlight in high color gamut LCD display. Thus, how to firmly fix the QD material in the backlight module is an issue needed to be solved currently.

### BRIEF SUMMARY OF THE DISCLOSURE

A main object of the present disclosure is to provide a backlight module, which can firmly fix the QD material in the backlight module.

The present disclosure provides a backlight module which includes a lamp strip and a light guide plate, and further includes a quantum dot glass tube and a fixing part, the fixing part being a hollow structure, the quantum dot glass tube being provided in the cavity of the fixing part which is positioned between the lame strip and the light guide plate, one side wall of the fixing part being abutting on the frame of the lamp strip, and the other side wall of the fixing part being engaging with the light guide plate.

Preferably, the side wall facing the lamp strip of the fixing part is provided with a plurality of first recesses arranged in turn, the shape of the first recess is matched with the shape of an LED lamp in the lamp strip, and after the frame of the first recess abuts on the frame of the lamp strip, one LED lamp is correspondingly received in one first recess.

Preferably, the side wall facing the lamp strip of the fixing part is provided with a second recess, the shape of the second recess is matched with the shape of the lamp strip, and after the frame of the second recess abuts on the frame of the lamp strip, the lamp strip is received in the second recess.

Preferably, the side wall facing the lamp strip of the fixing part is provided with a plurality of protrusions at the four corners or the four edges thereof respectively, the height of the protrusion is greater than the thickness of the lamp strip, and the protrusions are abutting on the frame of the lamp strip.

Preferably, the thickness of the light guide plate is reduced along the direction away from the fixing part.

The present disclosure also provides a backlight module which includes a lamp strip and a light guide plate, and further includes a quantum dot glass tube and a fixing part, the fixing part being a hollow structure, the quantum dot glass tube being provided in the cavity of the fixing part which is positioned between the lame strip and the light guide plate, one side wall of the fixing part being abutting on the frame of the lamp strip, and the other side wall of the fixing part being engaging with the light guide plate; the side wall facing the light guide plate of the fixing part is provided with an engaging groove, the width of the engaging groove being coincided with the thickness of the light guide plate, and the edge of the light guide plate being engaging in the engaging groove.

Preferably, the opposite side walls of the engaging groove to form extend position bars toward the cavity of the engaging groove respectively, the edge of the light guide plate is provided with guide slots at positions corresponding to the position bars, and the position bars are matched with the guide slots.

Preferably, the thickness of the light guide plate is reduced along the direction away from the fixing part.

Preferably, the side wall facing the lamp strip of the fixing part is provided with a plurality of first recesses arranged in turn, the shape of the first recess is matched with the shape of an LED lamp in the lamp strip, and after the frame of the first recess abuts on the frame of the lamp strip, one LED lamp is correspondingly received in one first recess.

Preferably, the side wall facing the lamp strip of the fixing part is provided with a second recess, the shape of the second recess is matched with the shape of the lamp strip, and after the frame of the second recess abuts on the frame of the lamp strip, the lamp strip is received in the second recess.

Preferably, the side wall facing the lamp strip of the fixing part is provided with a plurality of protrusions at the four corners or the four edges thereof respectively, the height of the protrusion is greater than the thickness of the lamp strip, and the protrusions are abutting on the frame of the lamp strip.

The present disclosure further provides a backlight module which includes a lamp strip and a light guide plate, and further includes a quantum dot optical film located between the lamp strip and the light guide plate, a side wall facing the quantum dot optical film of the light guide plate is provided with a third recess, and the quantum dot optical film is attached to the edge of the third recess.

Preferably, the third recess is provided with a plurality of folds at the bottom surface thereof.

Preferably, the thickness of the light guide plate is reduced along the direction away from the quantum dot optical film.

Preferably, there is a plurality of the third recesses, and each third recess corresponds to an LED lamp.

Preferably, there is one third recess, and the third recess corresponds to the whole lamp strip.

By means of utilizing the fixing part to place the quantum dot glass tube in the present disclosure, a proper distance is maintained among the lamp strip, the light guide plate and the quantum dot glass tube, and the lamp strip and the light guide plate can be fixed.

### BRIEF DESCRIPTION OF THE DRAWINGS

FIG. 1 is a schematically exploded view of the lamp strip, the light guide plate, the quantum dot glass tube and the fixing part in the backlight module of the first embodiment according to the present disclosure;

FIG. 2 is a schematically structural view of the fixing part in the backlight module of the first embodiment according to the present disclosure;

FIG. 3 is a schematically structural view of the fixing part provided with a first recess in the backlight module of the first embodiment according to the present disclosure;

FIG. 4 is a schematically structural view of the fixing part provided with a second recess in the backlight module of the first embodiment according to the present disclosure;

FIG. 5 is a schematically structural view of the fixing part provided with a protrusion in the backlight module of the first embodiment according to the present disclosure;

FIG. 6 is a schematically structural view of the light guide plate provided with a guide slot in the backlight module of the first embodiment according to the present disclosure;

FIG. 7 is a schematically structural view of the fixing part provided with a position bar in the backlight module of the first embodiment according to the present disclosure;

FIG. 8 is a schematically structural view of the light guide plate having a wedge shape in the backlight module of the first embodiment according to the present disclosure;

FIG. 9 is a schematically structural view of the backlight module of the second embodiment according to the present disclosure;

FIG. 10 is a schematically structural view of the light guide plate provided with a third recess in the backlight module of the second embodiment according to the present disclosure;

FIG. 11 is a schematically structural view of the light guide plate provided with a fold surface in the backlight module of the second embodiment according to the present disclosure.

The implementations, functional features and advantages of the present disclosure will be further described with reference to embodiments thereof and the accompanying drawings.

### DETAILED DESCRIPTION

It should be appreciate that, the embodiments described herein are only intended to illustrate but not to limit the present disclosure.

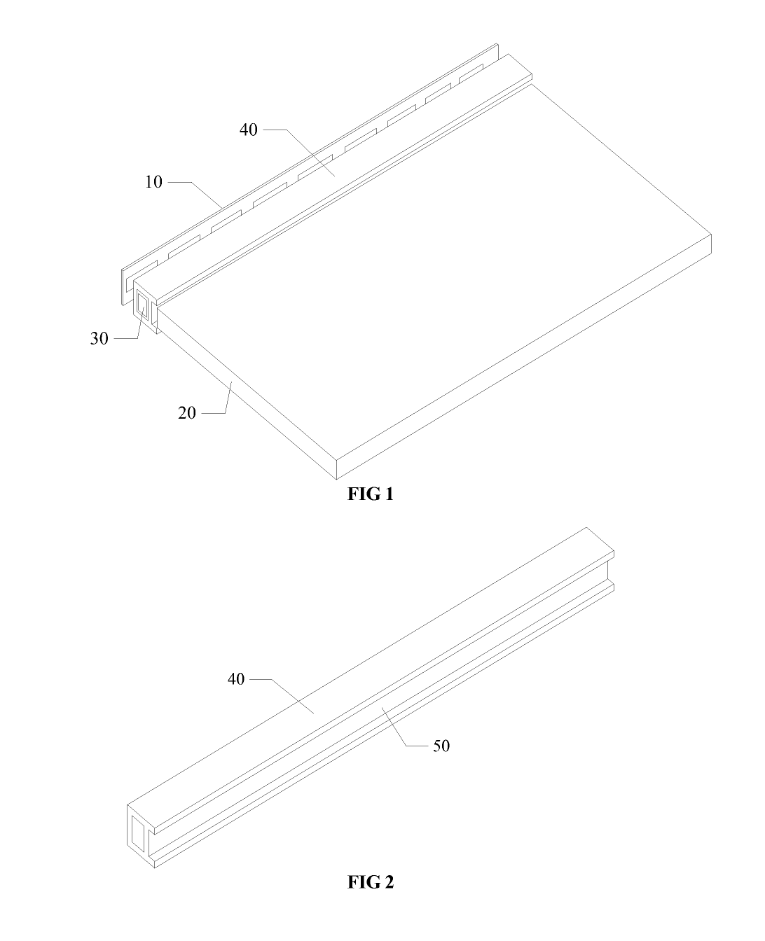

Referring to FIG. 1 and FIG. 2, FIG. 1 is a schematically exploded view of the lamp strip, the light guide plate, the quantum dot glass tube and the fixing part in the backlight module of the first embodiment according to the present disclosure, and FIG. 2 is a schematically structural view of the fixing part in the backlight module of the first embodiment according to the present disclosure.

The backlight module provided in the embodiment includes a lamp strip 10, a light guide plate 20, a quantum dot glass tube 30 and a fixing part 40, in which high-frequency LED light source can be used in the lamp strip 10 and the quantum dot glass tube 30 is designed to place quantum dot (QD) material into the glass tube. The quantum dot glass tube 30 can be a cuboid shape glass tube. Under irradiation of high-frequency LED light source, the QD material in the quantum dot glass tube 30 can be excited to produce spectrums having different colors, thus generates white backlight required by the backlight module.

To keep a proper distance among the lamp strip 10, the light guide plate 20 and the quantum dot glass tube 30, the fixing part 40 is adopted in the embodiment to place the quantum dot glass tube 30 and can fix the lamp strip 10 and the light guide plate 20. A detailed structure is as follows:

The fixing part 40 is a hollow structure, the quantum dot glass tube 30 is provided in the cavity of the fixing part 40 which is positioned between the lamp strip 10 and the light guide plate 20, one side wall of the fixing part 40 abuts on the frame of the lamp strip 10, and the other side wall of the fixing part 40 engages with the light guide plate 20. The side wall facing the light guide plate 20 of the fixing part 40 is provided with an engaging groove 50, the width of the engaging groove 50 is coincided with the thickness of the light guide plate 20, and the edge of the light guide plate 20 is engaging in the engaging groove 50, thus effectively prevent the light guide plate 20 from damage of impacting the quantum dot glass tube 30.

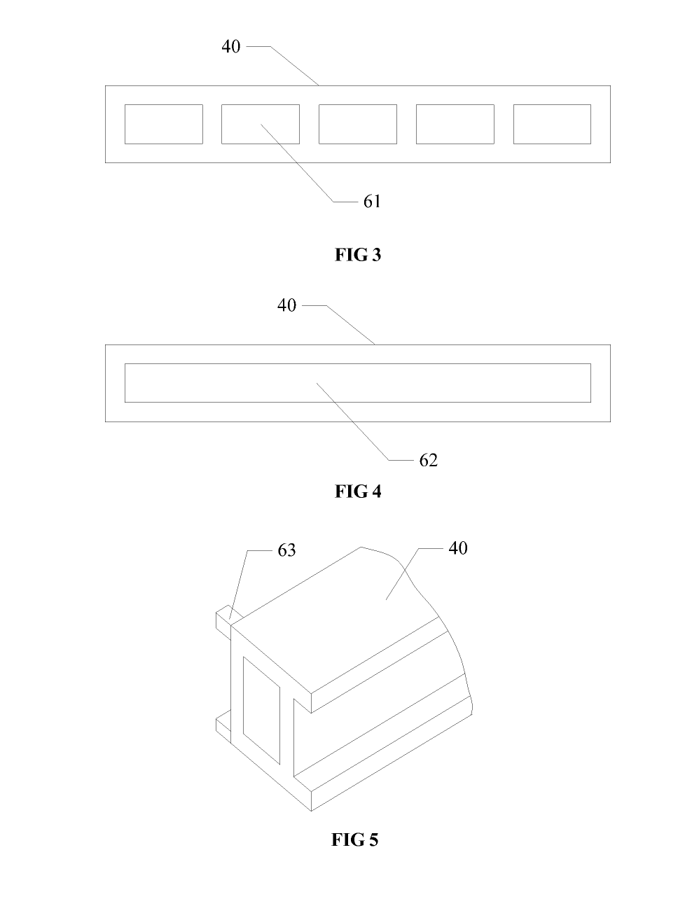

Referring to FIG. 3, FIG. 3 is a schematically structural view of the fixing part provided with a first recess in the backlight module of the first embodiment according to the present disclosure. The side wall facing the lamp strip 10 of the fixing part 40 is provided with a plurality of first recesses 61 arranged in turn, the shape of the first recess 61 is matched with the shape of an LED lamp in the lamp strip 10, and after the frame of the first recess 61 abuts on the frame of the lamp strip 10, each LED lamp is correspondingly received in each first recess 61. In this embodiment, the depth of the first recess 61 is slightly greater than the height of the LED lamp in the lamp strip 10, allowing a suitable interstice between the LED lamp received in the first recess 61 and the bottom of the first recess 61, which effectively avoids damage of the LED lamps caused by pressing due to the thermal expansion of the light guide plate 20.

Referring to FIG. 4, FIG. 4 is a schematically structural view of the fixing part provided with a second recess in the backlight module of the first embodiment according to the present disclosure. The difference between this embodiment and the embodiment shown in FIG. 3 is that, a second recess 62 in this embodiment is formed by connecting the plurality of first recesses in FIG. 3. The shape of the second recess 62, such as the elongated shape in this embodiment, is matched with the shape of the lamp strip 10. After the frame of the second recess 62 abuts on the frame of the lamp strip 10, the whole lamp strip 10 is received in the second recess 62. The depth of the second recess 62 is slightly greater than the height of the LED lamp in the lamp strip 10, allowing a suitable interstice between the lamp strip 10 received in the second recess 62 and the bottom of the first recess 62, which effectively avoids damage to the LED lamps caused by pressing due to the thermal expansion of the light guide plate 20.

Referring to FIG. 5, FIG. 5 is a schematically structural view of the fixing part 40 provided with a protrusion in the backlight module of the first embodiment according to the present disclosure. In order to improve the heat dissipation issue, the first recess shown in FIG. 3 or the second recess shown in FIG. 4 can be replaced by a protrusion 63. A plurality of protrusions 63 is provided respectively at the four corners or four edges of a side wall facing the lamp strip 10 of the fixing part 40. The protrusion 63 can be rectangular, cube, cylinder, prism, etc. The height of the protrusion 63 is larger than the thickness of the lamp strip 10. When the protrusions 63 abut on the frame of the lamp strip 10, there is an interstice between the lamp strip 10 and the fixing part 40, which also can effectively avoid damaging the LED lamps caused by pressing due to the thermal expansion of the light guide plate 20. Furthermore, the protrusions 63 can also be provided at the frame of the first recess in the embodiment shown in FIG. 3, or at the frame of the second recess in the embodiment shown in FIG. 4, which benefits the heat dissipation of LED and the like.

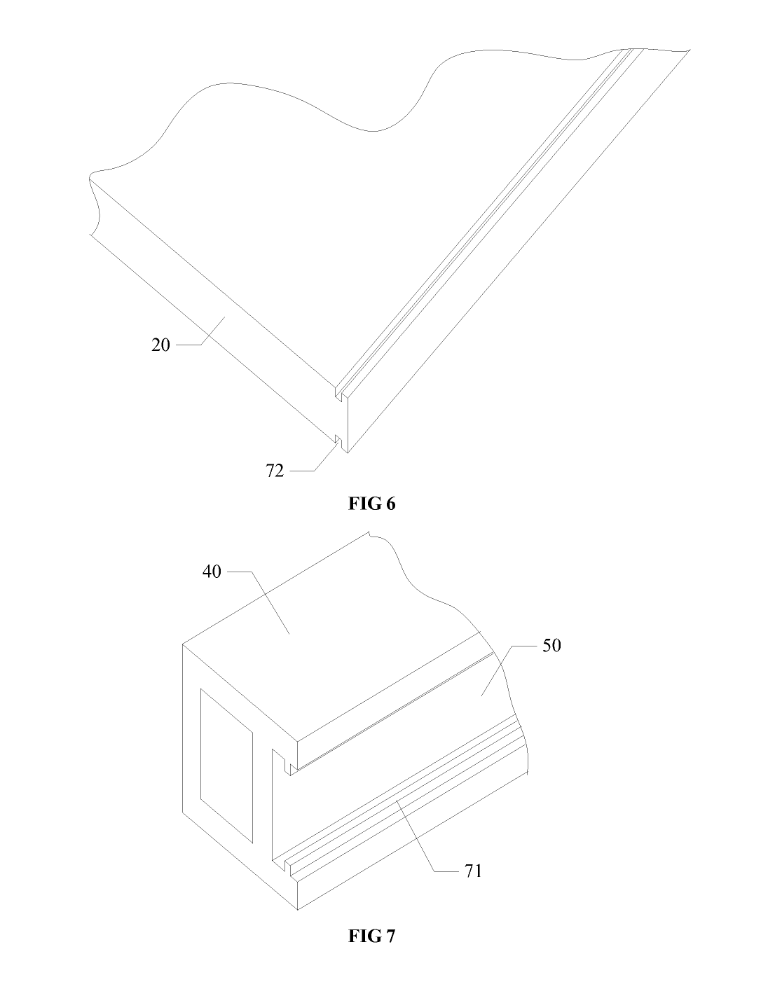

Referring to FIG. 6 and FIG. 7, FIG. 6 is a schematically structural view of the light guide plate provided with a guide slot in the backlight module of the first embodiment according to the present disclosure, and FIG. 7 is a schematically structural view of the fixing part provided with a position bar in the backlight module of the first embodiment according to the present disclosure. The difference between this embodiment and the embodiment shown in FIG. 2 is that, the opposite side walls of the engaging groove 50 extend to form position bars 71 facing the cavity of the engaging groove 50 respectively, the edge of the light guide plate 20 is provided with guide slots 72 at the positions corresponding to the position bars 71, the position bars 71 are matched with the guide slots 72 and slide into the guide slots 72 through an opening at a side face of the guide slots 72, achieving engagement between the position bars 71 and the guide slots 72, thus benefit to fix the connection between the light guide plate 20 and the fixing part 40.

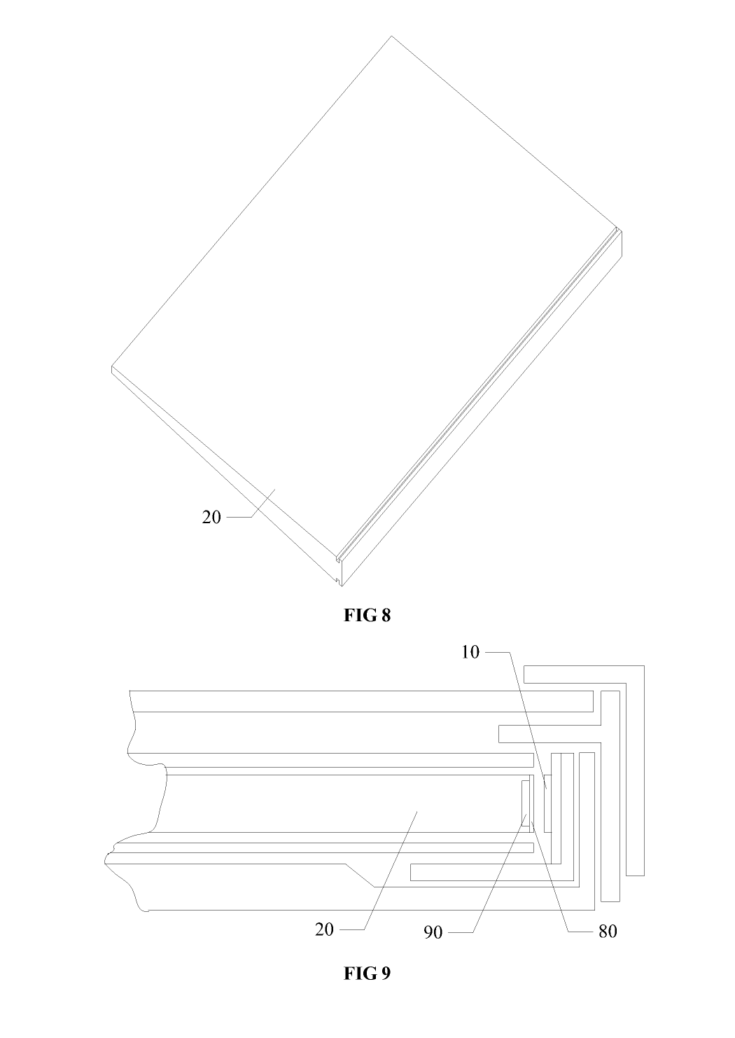

Referring to FIG. 8, FIG. 8 is a schematically structural view of the light guide plate having a wedge shape in the backlight module of the first embodiment according to the present disclosure. In this embodiment, the thickness of the light guide plate 20 is reduced along the direction away from the fixing part 40, forming a wedge shape, which benefit to reduce the thickness of the light guide plate 20, and further to reduce the weight of the whole backlight module.

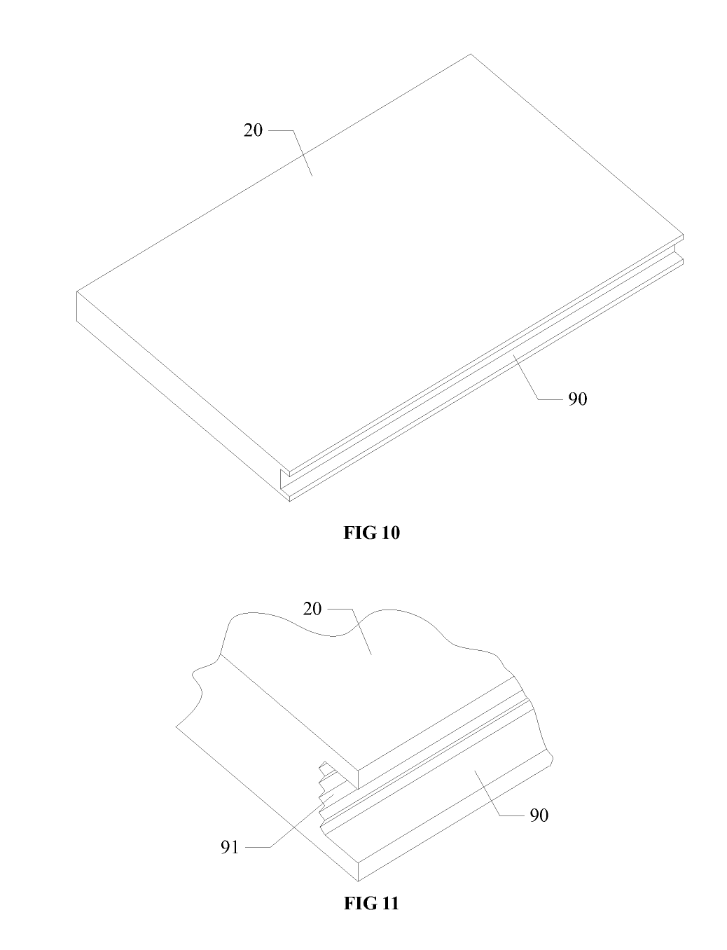

Referring to FIG. 9 and FIG. 10, FIG. 9 is a schematically structural view of the backlight module of the second embodiment according to the present disclosure, and FIG. 10 is a schematically structural view of the light guide plate 20 provided with a third recess 90 in the backlight module of the second embodiment according to the present disclosure.

The difference between the backlight module provided in the embodiment and the embodiments shown in FIG. 1 to FIG. 8 is that, besides including the lamp strip 10 and the light guide plate 20, the backlight module further includes a quantum dot optical film 80. The quantum dot optical film 80 is obtained by processing the QD material into an optical film. The quantum dot optical film 80 is located between the lamp strip 10 and the light guide plate 20. A side wall facing the quantum dot optical film 80 of the light guide plate 20 is provided with a third recess 90. The quantum dot optical film 80 is attached to the edge of the third recess 90. Only a very narrow quantum dot optical film 80 is needed, which will not affect the output of light, and at the same time, benefit to reduce the width of the backlight module to achieve a narrow frame LCD. The shape and the number of the third recess 90 can refer to those of the first recess in the embodiment shown in FIG. 3, such as there is a plurality of third recesses and each of which corresponds to an LED lamp; or to those of the second recess in the embodiment shown in FIG. 4, for example there is one third recess which corresponds to the whole lamp strip. In addition, to reduce the weight of the entire backlight module, the thickness of the light guide plate 20 can also be reduced in a direction away from the quantum dot optical film 80, i.e. it is designed to be wedge-shaped.

Referring to FIG. 11, FIG. 11 is a schematically structural view of the light guide plate 20 provided with a fold surface in the backlight module of the second embodiment according to the present disclosure. The difference between this embodiment and the embodiment shown in FIG. 10 is that, the third recess 90 is provided with a plurality of folds 91 at the bottom surface thereof, which benefit to improve the uniformity of the light.

What described above are only preferred embodiments of the present disclosure but are not intended to limit the scope of the present disclosure.

Accordingly, any equivalent structural or process flow modifications that are made on basis of the specification and the attached drawings or any direct or indirect applications in other technical fields shall also fall within the scope of the present disclosure.

What is claimed is:

1. A backlight module comprising a lamp strip and a light guide plate, and further comprising a quantum dot glass tube and a fixing part, the fixing part being a hollow structure, the quantum dot glass tube being provided in the cavity of the fixing part which is positioned between the lame strip and the light guide plate, one side wall of the fixing part being abutting on the frame of the lamp strip, and the other side wall of the fixing part being engaging with the light guide plate.

2. The backlight module according to claim 1, wherein the side wall facing the lamp strip of the fixing part is provided with a plurality of first recesses arranged in turn, the shape of the first recess is matched with the shape of an LED lamp in the lamp strip, and after the frame of the first recess abuts on the frame of the lamp strip, one LED lamp is correspondingly received in one first recess.

3. The backlight module according to claim 1, wherein the side wall facing the lamp strip of the fixing part is provided with a second recess, the shape of the second recess is matched with the shape of the lamp strip, and after the frame of the second recess abuts on the frame of the lamp strip, the lamp strip is received in the second recess.

4. The backlight module according to claim 1, wherein the side wall facing the lamp strip of the fixing part is provided with a plurality of protrusions at the four corners or the four edges thereof respectively, the height of the protrusion is greater than the thickness of the lamp strip, and the protrusions are abutting on the frame of the lamp strip.

5. The backlight module according to claim 1, wherein the thickness of the light guide plate is reduced along the direction away from the fixing part.

6. A backlight module comprising a lamp strip and a light guide plate, and further comprising a quantum dot glass tube and a fixing part, the fixing part being a hollow structure, the quantum dot glass tube being provided in the cavity of the fixing part which is positioned between the lame strip and the light guide plate, one side wall of the fixing part being abutting on the frame of the lamp strip, and the other side wall of the fixing part being engaging with the light guide plate; the side wall facing the light guide plate of the fixing part is provided with an engaging groove, the width of the engaging groove being coincided with the thickness of the light guide plate, and the edge of the light guide plate being engaging in the engaging groove.

7. The backlight module according to claim 6, wherein the opposite side walls of the engaging groove extend to form position bars facing the cavity of the engaging groove respectively, the edge of the light guide plate is provided with guide slots at positions corresponding to the position bars, and the position bars are matched with the guide slots.

8. The backlight module according to claim 7, wherein the thickness of the light guide plate is reduced along the direction away from the fixing part.

9. The backlight module according to claim 7, wherein the side wall facing the lamp strip of the fixing part is provided with a plurality of first recesses arranged in turn, the shape of the first recess is matched with the shape of an LED lamp in the lamp strip, and after the frame of the first recess abuts on the frame of the lamp strip, one LED lamp is correspondingly received in one first recess.

10. The backlight module according to claim 7, wherein the side wall facing the lamp strip of the fixing part is provided with a second recess, the shape of the second recess is matched with the shape of the lamp strip, and after the frame of the second recess abuts on the frame of the lamp strip, the lamp strip is received in the second recess.

11. The backlight module according to claim 7, wherein the side wall facing the lamp strip of the fixing part is provided with a plurality of protrusions at the four corners or the four edges thereof respectively, the height of the protrusion is greater than the thickness of the lamp strip, and the protrusions are abutting on the frame of the lamp strip.

12. A backlight module comprising a lamp strip and a light guide plate, and further comprising a quantum dot optical film located between the lamp strip and the light guide plate, a side wall facing the quantum dot optical film of the light guide plate is provided with a third recess, and the quantum dot optical film is attached to the edge of the third recess.

13. The backlight module according to claim 12, wherein the third recess is provided with a plurality of folds at the bottom surface thereof.

14. The backlight module according to claim 13, wherein the thickness of the light guide plate is reduced along the direction away from the quantum dot optical film.

15. The backlight module according to claim 12, wherein there is a plurality of the third recesses, and each third recess corresponds to an LED lamp.

16. The backlight module according to claim 12, wherein there is one third recess, and the third recess corresponds to the whole lamp strip.
